(19) United States
(12) Patent Application Publication
(10) Pub. No.: US 2025/0296543 A1
(43) Pub. Date: Sep. 25, 2025

(54) BRAKING SYSTEM AND METHOD FOR OPERATING A BRAKING SYSTEM

(71) Applicant: ZF Active Safety GmbH, Koblenz (DE)

(72) Inventors: Joachim Oster, Ernst (DE); Thorsten Sopp, Lahnstein (DE); Frank Schmidt, Brodenbach (DE); Stefan Kraemer, Illerich (DE); Tobias Oppermann, Hollnich (DE)

(73) Assignee: ZF Active Safety GmbH, Koblenz (DE)

(21) Appl. No.: 19/089,421

(22) Filed: Mar. 25, 2025

(30) Foreign Application Priority Data
Mar. 25, 2024 (DE) 102024108486.3

(51) Int. Cl. B60T 13/74; B60T 13/16; B60T 13/68

(52) U.S. Cl. CPC B60T 13/745; B60T 13/161; B60T 13/686; B60T 2220/04

(57) ABSTRACT

A braking system for a vehicle is disclosed, the braking system configured for selectively applying pressure to and relieving pressure from at least two pressure connections for brake actuators. The braking system comprises an electro-fluidic braking module with an electrically-actuatable pressure generating unit, a master cylinder module comprising a fluidic brake master cylinderactuatable by a brake pedal, wherein the electro-fluidic braking module and the master cylinder module are coupled to the pressure connections via at least one selector valve. The braking system also has a control unit which is designed to activate the electro-fluidic braking module and the at least one selector valve for applying pressure to the pressure connections, and to activate the electro-fluidic braking module to increase a fluid pressure in the master cylinder module while the at least one selector valve is in the first switching position. A method for operating a braking system is also provided.

### CROSS-REFERENCE TO RELATED APPLICATIONS

This application claims priority to German Patent Application No. 102024108486.3, filed Mar. 25, 2024, the disclosure of which is incorporated herein by reference in its entirety.

### TECHNICAL FIELD

The disclosure relates to a braking system for a vehicle and a method for operating a braking system.

### BACKGROUND

The braking system is configured for selectively applying pressure to and relieving pressure from at least two pressure connections for brake actuators, wherein each pressure connection can be coupled to an assigned brake actuator of a wheel of the vehicle. The braking system comprises an electro-fluidic braking module with an electrically actuatable pressure generating unit, wherein the electro-fluidic braking module is fluidically coupled to all pressure connections at least in a normal operating mode, so that pressure can be selectively applied to and relieved from the pressure connections. The braking system also has a master cylinder module which comprises a fluidic brake master cylinder which can be actuated by the brake pedal, wherein the master cylinder module is fluidically coupled to all pressure connections in a fallback mode, so that pressure can be selectively applied to and relieved from the pressure connections.

Such braking systems are known from the prior art. A brake actuator, for example, is a brake caliper which cooperates with a brake disk. The brake actuator has, for example, a fluidic slave cylinder.

In a normal operating mode, i.e. in an operating mode in which no defects or malfunctions are present in the braking system, pressure is selectively applied to or relieved from the pressure connections by means of the electro-fluidic braking module.

The master cylinder module also cooperates in the event that a driver interaction is provided in this normal operating mode, for example in the event that a driver's request is to be queried in this normal operating mode. However, the master cylinder module and the brake pedal merely serve to detect the driver's request. In this connection, the master cylinder module cooperates with a simulator unit which is known per se and which is configured to generate a restoring force on the brake pedal. The master cylinder module is not fluidically coupled to the pressure connections in normal operating mode. Such a normal operating mode is used in combination with a non-autonomous operating mode of an assigned vehicle.

In this connection, due to the absence of a fluidic coupling of the master cylinder module and the pressure connections, this is also referred to as a brake-by-wire system or a brake-by-wire operation.

In the event that a driver interaction is not desired or not provided in normal operating mode, a cooperation of the master cylinder module is not required. Such a normal operating mode is used, for example, in combination with an autonomous or partially autonomous operating mode of an assigned vehicle.

When the braking system is started when a driver actuates the ignition, the master cylinder module is initially coupled to the pressure connections. In this state it is possible that the driver pushes down on the brake pedal, whereby hydraulic fluid is conveyed to the pressure connections. If the connection from the master cylinder module to the pressure connections is closed after the starting process is terminated when the brake pedal is actuated, a deficit of hydraulic fluid is present in the master cylinder module, whereby during a braking process the brake pedal initially has to be actuated to a certain extent before a counterforce generated by the simulator unit can be perceived on the brake pedal. In this connection, this is also referred to as pedal failure. This can be irritating for a driver.

Thus, what is needed is a braking system with improved response behaviour.

### SUMMARY

A braking system for a vehicle is disclosed, wherein the braking system is configured for selectively applying pressure to and relieving pressure from at least two pressure connections for brake actuators, wherein each pressure connection can be coupled to an assigned brake actuator of a wheel of the vehicle. The braking system comprises a brake pedal for detecting a braking request of a driver, an electro-fluidic braking module with an electrically actuatable pressure generating unit and a master cylinder module which comprises a fluidic brake master cylinder which can be actuated by the brake pedal. The electro-fluidic braking module and the master cylinder module are coupled to the pressure connections via at least one selector valve. In a de-energized state, the at least one selector valve is pretensioned in a first switching position in which both the electro-fluidic braking module and the master cylinder module are fluidically connected to the pressure connections. In an energized state, the at least one selector valve is in a second switching position in which the electro-fluidic braking module is fluidically connected to the pressure connections and a connection from the master cylinder module to the pressure connections is blocked.

The braking system has a control unit which is designed to activate the electro-fluidic braking module and the at least one selector valve for applying pressure to the pressure connections. The control unit is also designed to activate the electro-fluidic braking module in order to increase a fluid pressure in the master cylinder module while the at least one selector valve is in the first switching position.

Since the control unit activates the electro-fluidic braking module when the selector valve is open, it is ensured that sufficient hydraulic fluid is present in the master cylinder module during a regular braking process, in order to ensure a sufficient counterforce over the entire travel of the pedal. In other words, a pressure equalization takes place in the master cylinder module. Thus, a feedback which can be easily perceived by the driver is generated on the brake pedal.

In one exemplary arrangement, the control unit is designed to detect an actuation of the brake pedal and to activate the electro-fluidic braking module in order to increase a fluid pressure in the master cylinder module when the brake pedal is actuated during a starting process of the braking system. In other words, the brake pedal was already actuated while the braking system was still de-energized. As a result, the brake pedal is moved back into its initial position by operation of the electro-fluidic braking module. The driver perceives this as the brake pedal being pushed back when the driver continues to place their foot on the brake pedal. Such a restoring of the brake pedal prevents a reduced fluid pressure prevailing in the master cylinder module.

A starting process of the braking system is understood to mean a start-up of the braking system when actuating the ignition or, in an electric vehicle, the start switch.

In a further scenario it is conceivable that by activating the electro-fluidic braking module, when the selector valve is open, a greater actuating force is required for actuating the brake pedal during the starting process of the braking system, so that from the start a driver is stopped from moving the brake pedal during the starting process. The greater actuating force is selected such that the driver can overcome the counterforce acting on the brake pedal in order to brake the vehicle, if required.

For example, in the first switching position of the at least one selector valve, the electro-fluidic braking module is fluidically connected to the pressure connections and to the master cylinder module via a non-return valve blocking in the direction of the electro-fluidic braking module. In this manner, during the starting process a brake pressure can be built up on the pressure connections so that the vehicle is prevented from rolling away during the starting process. For example, it is achieved that during the pressure equalization in the master cylinder module a braking force acts on the vehicle wheels, in the event that the driver actually wishes to produce a braking force by the actuation of the brake pedal during the starting process.

According to one exemplary arrangement, a path sensor and/or a pressure sensor are present, which are designed or which is designed to detect a brake pedal actuation and/or a fluid pressure in the master cylinder module, wherein the control unit is designed to stop an activation of the electro-fluidic braking module when the brake pedal is in its initial position and/or when a defined fluid pressure is reached in the master cylinder module. In this manner, an excessively high fluid pressure is prevented from building up in the master cylinder module.

The braking system can comprise a simulator unit which is fluidically connected to the master cylinder module and which is designed to generate a restoring force for the brake pedal, wherein a simulator valve is arranged between the simulator unit and the master cylinder module, wherein in a de-energized state the simulator valve is pretensioned in a first switching position in which a fluid flow from the master cylinder module to the simulator unit is blocked, and in an energized state the simulator valve is open. A restoring force which can be perceived on the brake pedal can be actively generated by the simulator unit. Since the simulator unit can be selectively fluidically connected via the selector valve to the master cylinder module or can be fluidically disconnected therefrom, it can be established when exactly the simulator unit is included in the generation of the restoring force.

In one exemplary arrangement, the control unit is designed to activate the simulator valve while the electro-fluidic braking module is activated in order to increase the fluid pressure in the master cylinder module. Thus, a pressure equalization can also take place in the simulator unit by activating the electro-fluidic braking module.

A method for operating a braking system as described above is also disclosed herein. In a first method step, the braking system is started by actuating an ignition. The control unit activates the electro-fluidic braking module after a restart of the braking system, while the at least one selector valve is in the first switching position, whereby hydraulic fluid is conveyed to the pressure connections and to the master cylinder module. Then the control unit activates the at least one selector valve, so that the electro-fluidic braking module and the master cylinder module are fluidically disconnected from one another and the master cylinder module is disconnected from the pressure connections.

As already explained in connection with the braking system according to the disclosure, in this manner it is ensured that sufficient hydraulic fluid is present in the master cylinder module in order to ensure during a braking process a sufficient counterforce on the brake pedal over the entire travel of the pedal.

According to one exemplary arrangement, the control unit detects whether the brake pedal is actuated during the starting process of the braking system and activates the electro-fluidic braking module while the at least one selector valve is in the first switching position, wherein the control unit stops the activation of the electro-fluidic braking module until there is a renewed actuation of the brake pedal and at the same time activates the at least one selector valve when the brake pedal has reached its initial position, whereby the master cylinder module is disconnected from the pressure connections. This means that as soon as the pressure equalization is completed, the control unit disconnects the master cylinder module from the pressure connections, whereby the braking system is brought into its normal operating state, so that in the subsequent braking processes a pressure on the pressure connections is varied solely by the electro-fluidic braking module.

The simulator valve can be activated during the activation of the electro-fluidic braking module, whereby hydraulic fluid is conveyed to the simulator unit. As a result, as already described in connection with the braking system, a pressure equalization can also take place in the simulator unit.

During the operation of the braking system, the selector valve can remain permanently activated from the first activation so that the master cylinder module is permanently disconnected from the pressure connections, whereby a pressure equalization has to take place only when the braking system is started. In this manner, the electronic activation of the braking system is simplified.

The master cylinder module can be connected to the pressure connections by the elimination of the activation of the selector valve, only in the case of a power failure, whereby a hydraulic intervention is possible from the master cylinder module to the pressure connections.

### BRIEF DESCRIPTION OF THE DRAWINGS

Further advantages and features of the disclosure are found in the following description and in the accompanying single drawing, to which reference is made.

FIG. 1 shows a braking system 10 for a vehicle.

### DETAILED DESCRIPTION

In the exemplary arrangement shown, the braking system 10 is configured to be used in a vehicle which has a total of four wheels.

Accordingly, the braking system 10 comprises four pressure connections 12a, 12b, 12c, 12d which in the present case are configured as hydraulic pressure connections.

The pressure connection 12a is coupled to a brake actuator 14a which is assigned to one of the wheels of the vehicle. For example, the brake actuator 14a is a front left brake actuator.

The pressure connection 12b is coupled to a brake actuator 14b which is also assigned to one of the wheels of the vehicle. For example, the brake actuator 14b is a rear right brake actuator.

The pressure connection 12c is coupled to a brake actuator 14c. This brake actuator is also assigned to one of the wheels of the vehicle. For example, the brake actuator 14c is a front right brake actuator.

The pressure connection 12d is coupled to a brake actuator 14d which is also assigned to one of the wheels of the vehicle. For example, the brake actuator 14d is a rear left brake actuator.

The braking system 10 is selectively configured to apply pressure to or to relieve pressure from each of the pressure connections 12a, 12b, 12c, 12d. A pressure relief is understood to mean that a pressure previously applied is removed again.

In this manner, the brake actuators 14a, 14b, 14c, 14d can be actuated by operation of the braking system 10.

To this end, the braking system 10 comprises an electro-fluidic braking module 16 with an electrically actuatable pressure generating unit 18.

This pressure generating unit has a pressure chamber 20 to which pressure can be applied or from which pressure can be relieved selectively by a displaceable piston 22.

To this end, the piston 22 is coupled in terms of drive to an electrically actuatable spindle drive 24 in a bi-directional manner.

A master cylinder module 26 is also provided.

This master cylinder module comprises a fluidic, i.e. here hydraulic, brake master cylinder 28 with a primary piston 30 and a secondary piston 32. The primary piston 30 defines a first pressure chamber 34 inside the brake master cylinder 28 and the secondary piston 32 defines a second pressure chamber 36.

The primary piston 30 and the secondary piston 32 are also displaceable inside the brake master cylinder 28 by a brake pedal 38. In other words, the brake master cylinder 28 can be actuated by the brake pedal 38.

In this manner, a pressure can be generated or a pressure can be relieved selectively in the pressure chambers 34, 36.

The brake pedal 38 serves for detecting a braking request of a driver.

The first electro-fluidic braking module 16 and the master cylinder module 26 are both coupled to a fluid reservoir 40. Brake fluid is always available in a sufficient quantity to the first electro-fluidic braking module 16 and the master cylinder module 26.

The braking system 10 shown in the figures comprises two brake circuits.

A first brake circuit serves for selectively supplying pressure to or relieving pressure from the pressure connections 12a and 12b. A second brake circuit serves for selectively applying pressure to or relieving pressure from the pressure connections 12c and 12d.

Both the electro-fluidic braking module 16 and the master cylinder module 26 are configured to supply pressure to or relieve pressure from all of the pressure connections 12a, 12b, 12c, 12d.

To this end, a pressure outlet line 42 leading from the electro-fluidic braking module 16 is coupled both to a first selector valve 44 and to a second selector valve 46.

Moreover, a first pressure outlet line 48 of the master cylinder module 26 is coupled to the first selector valve 44 and a second pressure outlet line 50 of the master cylinder module 26 is coupled to the second selector valve 46.

The two selector valves 44, 46 are designed as 3/2-way valves. The selector valves have in each case two valve inlets and in each case one valve outlet.

The selector valves 44, 46 are also switching valves.

In a de-energized state, the selector valves 44, 46 are pretensioned in each case into a first switching position in which both the electro-fluidic braking module 16 and the master cylinder module 26 are fluidically connected to the pressure connections 12a, 12b, 12c, 12d.

For example, the pressure outlet lines 48 or 50 are connected to the valve outlet when the selector valves 44, 46 are in the first switching position.

Moreover, in this switching position of the selector valves 44, 46 the electro-fluidic braking module 16 is fluidically connected to the pressure connections 12a, 12b, 12c, 12d and to the master cylinder module 26 via a non-return valve 51 blocking in the direction of the electro-fluidic braking module 16. In other words, the valve outlet is connected to the pressure outlet line 42 via the non-return valve 51 such that a flow from the pressure outlet line 42 is possible in the direction of the valve outlet but a flow in the reverse direction is blocked.

The selector valves 44, 46 adopt a second switching position when they are actuated, for example energized.

If the selector valves 44, 46 are in the second switching position, the electro-fluidic braking module 16 is fluidically connected to the pressure connections 12a, 12b, 12c, 12d and a connection from the master cylinder module 26 to the pressure connections 12a, 12b, 12c, 12d is blocked.

In one exemplary arrangement, the pressure outlet line 42 is connected in each case to the valve outlet when the selector valves 44, 46 are in the second switching position. The pressure outlet lines 48, 50 are blocked in each case.

Moreover, a path sensor 53 and pressure sensors 55, which are designed to detect a brake pedal actuation and a fluid pressure in the master cylinder module 26, are present. The path sensor 53 is arranged, for example, on a pivot point of the brake pedal 38. The pressure seniors 55 are arranged, for example, in the pressure outlet lines 48, 50.

A force sensor 57 can be present alternatively or additionally to a path sensor 53.

A first pressurization line 52a which is fluidically connected to the first pressure connection 12a is connected to the valve outlet of the first selector valve 44. An inlet valve 54a is arranged inside the first pressurization line 52a.

Moreover, a second pressurization line 52b which is connected to the pressure connection 12b leads from the first selector valve 44. An inlet valve 54b is arranged inside the pressurization line 52b.

Moreover, the pressure connection 12a is connected to a pressure relief line 56a which is connected via an outlet valve 58a to a return line 60 which leads to the fluid reservoir 40.

In the same manner, the pressure connection 12b is connected to a pressure relief line 56b which is connected via an outlet valve 58b to the return line 60.

Additionally a simulator unit 62, which is fluidically connected to the master cylinder module 26 and which is designed in a manner known per se to generate a restoring force for the brake pedal 38, is connected to the pressure outlet line 48.

A simulator valve 63 is arranged between the simulator unit 62 and the master cylinder module 26, wherein in a de-energized state the simulator valve 63 is pretensioned in a first switching position in which a fluid flow from the master cylinder module 26 to the simulator unit 62 is blocked, and in an energized state the simulator valve 63 is open.

A pressurization line 52c, in which an inlet valve 54c is arranged, leads from the valve outlet of the second selector valve 46. The pressure connection 12c can be supplied with pressure via the pressurization line 52c.

Moreover, a pressurization line 52d is provided, said pressurization line leading from the valve outlet of the second selector valve 46 and an inlet valve 54d being positioned therein. The pressure connection 12d can be supplied with pressure via the pressurization line 52d.

Moreover, a pressure relief line 56c, in which an outlet valve 58c is provided, is provided on the pressure connection 12c.

In the same manner, the pressure connection 12d is connected to a pressure relief line 56d in which an outlet valve 58d is provided.

The pressure relief lines 56c, 56d are connected to the return line 60.

In this connection, the inlet valves 54a and 54c are designed as switchable non-return valves. In an unactuated, for example de-energized, state only the respectively assigned selector valve 44, 46 can be energized in the direction of the assigned pressure connections 12a, 12c via the inlet valves 54a, 54c.

In an actuated, for example energized, state of the inlet valves 54a, 54c these inlet valves are blocked. This means that the pressurization lines 52a, 52c are not able to be flowed through in any direction.

The inlet valves 54b, 54d are designed as 2/2-way valves.

The inlet valves 54b, 54d are pretensioned into a first switching position in which the respectively assigned pressurization line 52b, 52d can be flowed through in both directions. This position corresponds to an unactuated state.

All of the inlet valves 54a, 54b, 54c, 54d are switching valves.

The outlet valves 58a, 58b, 58c, 58d are all designed in the same manner as 2/2-way valves. They are also switching valves.

The outlet valves 58a, 58b, 58c, 58d are pretensioned in each case into a switching position in which they act as non-return valves. In this connection, only a flow from the return line 60 in the direction of the respectively assigned pressure connection 12a, 12b, 12c, 12d is open. The reverse flow direction is blocked.

If the outlet valves 58a, 58b, 58c, 58d are switched, i.e. actuated, the respectively assigned pressure relief line 56a, 56b, 56c, 56d can be flowed through in both directions.

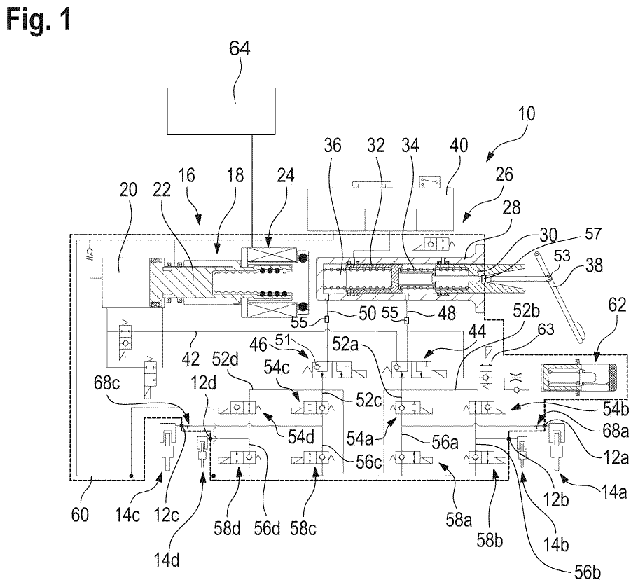

The braking system 10 also has a control unit 64 which is designed to activate the electro-fluidic braking module 16 and the selector valves 44, 46 for applying pressure to the pressure connections 12a, 12b, 12c, 12d. Only the signal-technical connection of the control unit 64 to the electro-fluidic braking module 16 is illustrated in FIG. 1 for the sake of simplicity.

In one exemplary arrangement, the control unit 64 is designed to activate the electro-fluidic braking module 16 in order to increase a fluid pressure in the master cylinder module 26 while the at least one selector valve 44, 46 is in the first switching position.

Specifically, the control unit 64 is designed to detect an actuation of the brake pedal 38 and to activate the electro-fluidic braking module 16 in order to increase a fluid pressure in the master cylinder module 26 when the brake pedal 38 is actuated during a starting process of the braking system 10.

The control unit 64 is also designed to stop an activation of the electro-fluidic braking module 16 when the brake pedal 38 is in its initial position and/or when a defined fluid pressure is reached in the master cylinder module 26.

Moreover, the control unit 64 is designed to activate the simulator valve 63 while the electro-fluidic braking module 16 is activated in order to increase the fluid pressure in the master cylinder module 26.

The braking system 10 can be operated as follows:

Initially the braking system 10 is started, for example by actuating an ignition or a start button.

The selector valves 44, 46 and the simulator valve 63 are initially in the first switching position since the entire braking system 10 is de-energized before the start.

After a restart of the braking system 10, the control unit 64 activates the electro-fluidic braking module 16 while the at least one selector valve 44, 46 is in the first switching position, whereby hydraulic fluid is conveyed to the pressure connections 12a, 12b, 12c, 12d and to the master cylinder module 26. In this manner, after the restart of the braking system 10 it is ensured that the brake pedal 38 is in a neutral position even if the driver has moved the brake pedal 38 during the restart.

Since the selector valves 44, 46 are de-energized during the restart, hydraulic fluid can be conveyed to the pressure connections 12a, 12b, 12c, 12d, namely by an actuation of the brake pedal 38 during the restart. If the selector valves 44, 46 are activated while the brake pedal 38 is actuated, this results in a deficit of hydraulic fluid in the master cylinder module 26 which can have a disadvantageous effect on subsequent braking processes, for example on the restoring force acting on the brake pedal 38.

For example, using the path sensor 53, the pressure sensors 55 or the force sensor 57, the control unit 64 detects whether the brake pedal 38 is actuated during the starting process of the braking system 10.

The control unit 64 stops the activation of the electro-fluidic braking module 16 and at the same time activates the selector valves 44, 46 when the brake pedal 38 has reached its initial position, whereby the master cylinder module 26 is disconnected from the pressure connections 12a, 12b, 12c, 12d.

Subsequently the control unit 64 activates the at least one selector valve 44, 46 so that the electro-fluidic braking module 16 and the master cylinder module 26 are fluidically disconnected from one another and the master cylinder module 26 is disconnected from the pressure connections 12a, 12b, 12c, 12d. In this manner, it is achieved that sufficient hydraulic fluid is available in the master cylinder module 26.

In addition, the control unit 64 can activate the simulator valve 63 during the activation of the electro-fluidic braking module 16, whereby hydraulic fluid is conveyed to the simulator unit 62. Thus, it is additionally achieved that sufficient hydraulic fluid is available in the simulator unit 62.

After the end of the starting process the braking system 10 is operated in a normal operating mode.

In normal operation in which the braking system is free of defects and malfunctions, the selector valves 44, 46 are in each case in the actuated position thereof. For example, during the operation of the braking system 10, the selector valves 44, 46 are permanently activated from the first activation, provided a power failure does not occur in the braking system 10.

The inlet valves 54a and 54c are unactuated in normal operation, i.e. they act as non-return valves.

The inlet valves 54b and 54d are also unactuated and thus open up the associated pressurization line 52b, 52d.

Thus the electro-fluidic braking module 16 is fluidically coupled to all of the pressure connections 12a, 12b, 12c, 12d.

The outlet valves 58a, 58b, 58c, 58d are unactuated in each case, i.e. are blocked for a flow in the direction of the return line 60.

The master cylinder module 26 is connected to the simulator unit 62 via the pressure outlet line 48.

The braking system 10 can thus be operated in a so-called brake-by-wire operation. An actuation of the brake pedal 38 by a driver is detected by sensor, for example by operation of the path sensor 53, the pressure sensor 55 and/or the force sensor 57. Using the resulting sensor values, control commands are generated for the electrically actuatable pressure generating unit 18.

On this basis, the piston 22 is displaced by an electric motor, for example, such that the pressure chamber 20 is pressurized and thus pressure is applied to each of the pressure connections 12a, 12b, 12c, 12d.

If the pressure connections 12a, 12b, 12c, 12d are to be relieved of pressure again, the pressure chamber 20 is relieved of pressure by displacing the piston 22 in an opposing direction. This results in pressure being relieved at the pressure connections 12a, 12b, 12c, 12d.

In this connection, a functionality of an anti-lock braking system (ABS) can also be provided since one or more of the outlet valves 58a, 58b, 58c, 58d is or are selectively switched, i.e. opened. This leads to a pressure drop at the respectively assigned pressure connection 12a, 12b, 12c, 12d. Alternatively or additionally, one or more of the inlet valves 54a, 54b, 54c, 54d can be switched, which leads to a further build-up of pressure at the assigned pressure connection 12a, 12b, 12c, 12d being blocked.

The braking system 10 also remains functional in the event of a defect or a malfunction occurring on the first electro-fluidic braking module 16. This operating mode is denoted as fallback mode.

In this connection, the selector valves 44, 46 are transferred to their unactuated state. This takes place either due to the pretensioning of the selector valves 44, 46 or by a defined removal of an actuating signal, for example in the event of a failure of a power supply. The inlet valves 54a, 54b, 54c, 54d and the outlet valves 58a, 58b, 58c, 58d are in each case in their unactuated state. This is also implemented via the respectively present pretensioning or by a defined switch-off.

As a whole, no power supply is required from outside in order to transfer the valves into the above-mentioned switching positions.

For example, in this state it is possible to build up pressure in the pressure chambers 34, 36 by actuating the brake pedal 38, the pressure being provided to all of the pressure connections 12a, 12b, 12c, 12d via the selector valves 44, 46. In other words, a hydraulic intervention is possible from the master cylinder module 26 to the pressure connections 12a, 12b, 12c, 12d.

1. A braking system for a vehicle, wherein the braking system is configured for selectively applying pressure to, and relieving pressure from, at least two pressure connections for brake actuators, wherein each pressure connection can be coupled to an assigned brake actuator of a wheel of the vehicle, comprising:
a brake pedal for detecting a braking request of a driver,
an electro-fluidic braking module with an electrically actuatable pressure generating unit,
a master cylinder module which comprises a fluidic brake master cylinder which can be actuated by the brake pedal,
wherein the electro-fluidic braking module and the master cylinder module are coupled to the pressure connections via at least one selector valve,
wherein in a de-energized state the at least one selector valve is pretensioned into a first switching position in which both the electro-fluidic braking module and the master cylinder module are fluidically connected to the pressure connections, and
wherein in an energized state the at least one selector valve is in a second switching position in which the electro-fluidic braking module is fluidically connected to the pressure connections and a connection from the master cylinder module to the pressure connections is blocked,
wherein the braking system has a control unit which is designed to activate the electro-fluidic braking module and the at least one selector valve for applying pressure to the pressure connections, and
wherein the control unit is designed to activate the electro-fluidic braking module in order to increase a fluid pressure in the master cylinder module while the at least one selector valve is in the first switching position.

2. The braking system according to claim 1, wherein the control unit is designed to detect an actuation of the brake pedal and to activate the electro-fluidic braking module in order to increase a fluid pressure in the master cylinder module when the brake pedal is actuated during a starting process of the braking system.

3. The braking system according to claim 1, wherein in the first switching position of the at least one selector valve, the electro-fluidic braking module is fluidically connected to the pressure connections and to the master cylinder module via a non-return valve blocking in the direction of the electro-fluidic braking module.

4. The braking system according to claim 1, wherein a path sensor and/or a pressure sensor is present, which are designed or which is designed to detect a brake pedal actuation and/or a fluid pressure in the master cylinder module, wherein the control unit is designed to stop an activation of the electro-fluidic braking module when the brake pedal is in its initial position and/or when a defined fluid pressure is reached in the master cylinder module.

5. The braking system according to claim 1, wherein the braking system comprises a simulator unit which is fluidically connected to the master cylinder module and which is designed to generate a restoring force for the brake pedal, wherein a simulator valve is arranged between the simulator unit and the master cylinder module, wherein in a de-energized state the simulator valve is pretensioned into a first switching position in which a fluid flow from the master cylinder module to the simulator unit is blocked, and in an energized state the simulator valve is open.

6. The braking system according to claim 5, wherein the control unit is designed to activate the simulator valve while the electro-fluidic braking module is activated in order to increase the fluid pressure in the master cylinder module.

7. A method for operating a braking system according to claim 1, comprising the following steps:
actuating an ignition to start the braking system,
activating the electro-fluidic braking module by the control unit after a restart of the braking system while the at least one selector valve is in the first switching position, whereby hydraulic fluid is conveyed to the pressure connections and to the master cylinder module, and
activating the at least one selector valve by the control unit, so that the electro-fluidic braking module and the master cylinder module are fluidically disconnected from one another and the master cylinder module is disconnected from the pressure connections.

8. The method according to claim 7, wherein the control unit detects whether the brake pedal is actuated during the starting process of the braking system and the control unit activates the electro-fluidic braking module while the at least one selector valve is in the first switching position and wherein the control unit stops the activation of the electro-fluidic braking module (until there is a renewed actuation of the brake pedal and at the same time activates the at least one selector valve when the brake pedal has reached its initial position, whereby the master cylinder module is disconnected from the pressure connections.

9. The method according to claim 7 for operating the braking system that further comprises a simulator unit which is fluidically connected to the master cylinder module and which is designed to generate a restoring force for the brake pedal, wherein a simulator valve is arranged between the simulator unit and the master cylinder module, wherein in a deenergized state, the simulator valve is pretensioned into a first switching position in which a fluid flow from the master cylinder module to the simulator unit is blocked, and in an energized state, the simulator valve is open, wherein the method further comprises activating the simulator valve during the activation of the electro-fluidic braking module (16), whereby hydraulic fluid is conveyed to the simulator unit.

10. The method according to claim 7, wherein during the operation of the braking system, the selector valve remains permanently activated from the first activation.

11. The braking system according to claim 2, wherein in the first switching position of the at least one selector valve, the electro-fluidic braking module is fluidically connected to the pressure connections and to the master cylinder module via a non-return valve blocking in the direction of the electro-fluidic braking module.

12. The braking system according to claim 11, wherein a path sensor and/or a pressure sensor is present, which are designed or which is designed to detect a brake pedal actuation and/or a fluid pressure in the master cylinder module, wherein the control unit is designed to stop an activation of the electro-fluidic braking module when the brake pedal is in its initial position and/or when a defined fluid pressure is reached in the master cylinder module.

13. The braking system according to claim 12, wherein the braking system comprises a simulator unit which is fluidically connected to the master cylinder module and which is designed to generate a restoring force for the brake pedal, wherein a simulator valve is arranged between the simulator unit and the master cylinder module, wherein in a de-energized state the simulator valve is pretensioned into a first switching position in which a fluid flow from the master cylinder module to the simulator unit is blocked, and in an energized state the simulator valve is open.

14. The braking system according to claim 13, wherein the control unit is designed to activate the simulator valve while the electro-fluidic braking module is activated in order to increase the fluid pressure in the master cylinder module.

15. The method according to claim 8 for operating the braking system that further comprises a simulator unit which is fluidically connected to the master cylinder module and which is designed to generate a restoring force for the brake pedal, wherein a simulator valve is arranged between the simulator unit and the master cylinder module, wherein in a deenergized state, the simulator valve is pretensioned into a first switching position in which a fluid flow from the master cylinder module to the simulator unit is blocked, and in an energized state, the simulator valve is open, wherein the method further comprises activating the simulator valve during the activation of the electro-fluidic braking module, whereby hydraulic fluid is conveyed to the simulator unit.

16. The method according to claim 15, wherein during the operation of the braking system, the selector valve remains permanently activated from the first activation.
